(19) United States
(12) Patent Application Publication
(10) Pub. No.: US 2016/0054976 A1
(43) Pub. Date: Feb. 25, 2016

(54) METHOD FOR PRODUCING MEDIA CONTENTS IN DUET MODE AND APPARATUS USED THEREIN

(71) Applicant: Cheol SEOK, Daegu (KR)

(72) Inventors: Cheol SEOK, Daegu (KR); Ho-Kwang CHOI, Gyeonggi-do (KR)

(21) Appl. No.: 14/888,819

(22) PCT Filed: May 3, 2013
(86) PCT No.: PCT/KR2013/003836

§ 371 Date: Nov. 3, 2015

(51) Int. Cl. G06F 3/16; G11B 27/031

(52) U.S. Cl. CPC G06F 3/165; G11B 27/031

(57) ABSTRACT

Disclosed are a method for producing media contents in a duet mode and an apparatus used therein. The present invention is embodied by enabling a media file editing apparatus to reproduce a multi-track audio file in which an accompaniment track and a vocal track corresponding to the accompaniment track are synthesized with each other, to receive a volume control command of a vocal track from the user, and to produce a volume control value according to the volume control command. According to the present invention, the user himself or herself may produce media contents recorded with an original singer's voice of a user's favorite song and the user's voice in a duet mode.

### TECHNICAL FIELD

The present invention relates to a method for producing media contents in a duet mode and an apparatus used therein, and more specifically, to a method for producing media contents in a duet mode and an apparatus used therein enabling a user himself or herself to produce media contents recorded with an original singer's voice of a user's favorite song and the user's voice in a duet mode.

### BACKGROUND ART

Compared to a solo song sung by a singer alone, a duet song sung by two singers who sing together while harmonically making their own tones may often transmit richer emotion to listeners.

Meanwhile, music lovers or potential singers who like a specific singer may want to sing their favorite songs with a singer singing the songs in a duet mode or to possess and appreciate songs sung together.

However, there is only a method for inviting a singer in question to a studio to sing a song together and storing and possessing the song in order to realize such a wish in the related art.

### DISCLOSURE

### Technical Problem

Accordingly, it is an object of the present invention is to provide a method for producing media contents in a duet mode and an apparatus used therein enabling a user himself or herself to produce media contents recorded with an original singer's voice of a user's favorite song and the user's voice in a duet mode.

### Technical Solution

According to an aspect of the present invention, there is provided a method for producing media contents in a duet mode, including: (a) reproducing, by a media file editing apparatus, a multi-track audio file in which an accompaniment track and a vocal track corresponding to the accompaniment track are synthesized with each other; (b) receiving, by the media file editing apparatus, a volume control command of the vocal track from a user; and (c) producing, by the media file editing apparatus, a volume control value according to the volume control command.

Preferably, the method further includes: generating, by the media file editing apparatus, a synthesized audio file by synthesizing a vocal track data to which the generated volume control value is applied, the accompaniment track data, and an a user's voice data.

In addition, the method may further include: combining, by the media file editing apparatus, the synthesized audio file with a moving picture file.

The number of volume control values and the number of samples of the vocal track data may be the same as each other.

According to another aspect of the present invention, there is provided an apparatus for producing media contents, including: a reproducing unit configured to reproduce a multi-track audio file in which an accompaniment track and a vocal track corresponding to the accompaniment track are synthesized with each other; an input unit configured to receive a volume control command of the vocal track from a user; and an editing unit configured to generate a volume control value according to the volume control command.

Preferably, the apparatus further includes: a mixing unit configured to generate a synthesized audio file by synthesizing a vocal track data to which the volume control value generated by the editing unit is applied, the accompaniment track data, and an a user's voice data.

The editing unit may combine the synthesized audio file with a moving picture file.

The number of volume control values and the number of samples of the vocal track data may be the same as each other.

### Advantageous Effects

According to the present invention, the user himself or herself may produce media contents recorded with an original singer's voice of a user's favorite song and the user's voice in a duet mode.

### DESCRIPTION OF DRAWINGS

FIG. 1 is a view describing a structure of a multi-track audio file used in the present invention.

FIG. 2 is a functional block diagram illustrating a structure of an apparatus for producing media contents in a duet mode according to an embodiment of the present invention.

FIG. 3 is a flow chart describing an execution process of a method for producing media contents in a duet mode according to a first embodiment of the present invention.

FIG. 4 is a flow chart describing an execution process of a method for producing media contents in a duet mode according to a second embodiment of the present invention.

FIG. 5 is a flow chart describing an execution process of a method for producing media contents in a duet mode according to a third embodiment of the present invention.

### BEST MODE

Hereinafter, the present invention will be described in more detail with reference to accompanying drawings. In the drawings, same reference numerals denote same components throughout the disclosure. Known functions and configurations which may unnecessarily obscure the gist of the present invention will not be described.

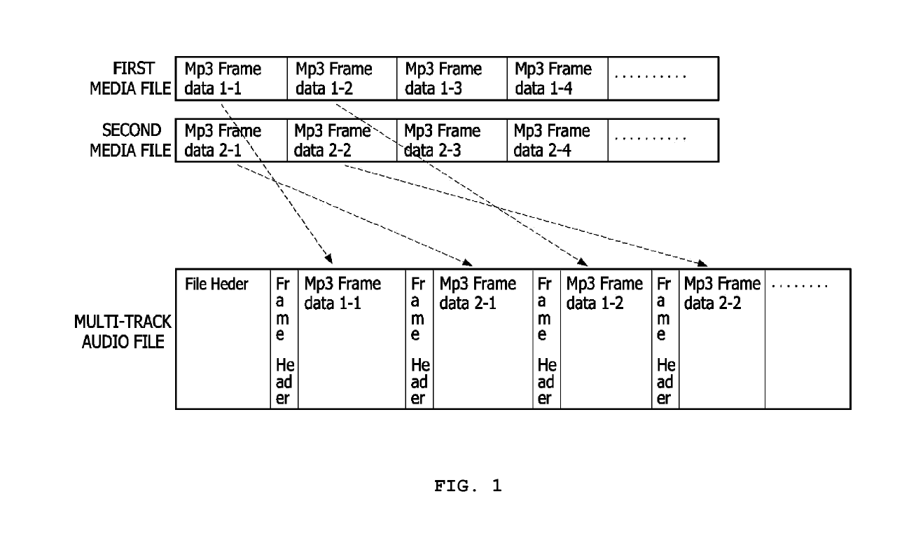

FIG. 1 is a view describing a structure of a multi-track audio file used in the present invention. As illustrated in FIG. 1, the multi-track audio file used in the present invention has a structure in which a first media file and at least one second media file corresponding to the first media file are synthesized with each other.

In detail, the first media file may be a vocal MP3 file in which only a vocal part of a singer is stored and the second media file may be a music recorded (MR) MP3 file in which only an accompaniment part is stored.

As illustrated in FIG. 1, the multi-track media file in which a vocal track (first media file) and an accompaniment track (second media file) are synthesized with each other includes a file header and a data part combined with the file header. The data part has a structure in which each frame of the first media file and each frame of the second frame file are adjacently combined with each other.

Specifically, behind a first frame data 1-1 of the first media file, a first frame data 2-1 of a second media file corresponding thereto are adjacently connected, and then a second frame data 1-2 of the first media file and a second frame data 2-2 of the second media file corresponding thereto are adjacently connected with each other.

Meanwhile, the file header is recorded with information on the total number of the synthesized media files and the total number of frames of the data part as information of the multi-track media file.

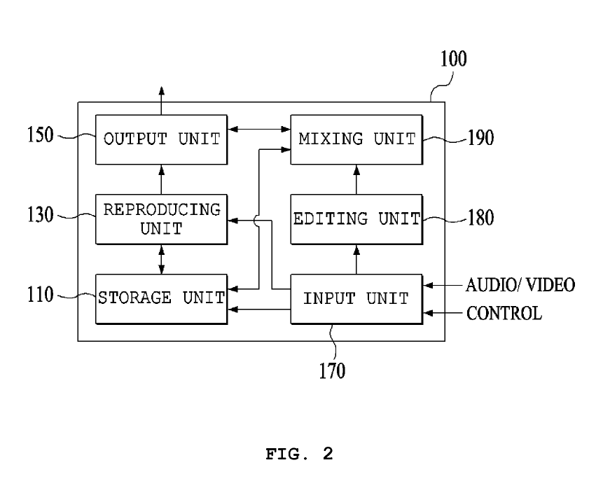

FIG. 2 is a functional block diagram illustrating a structure of an apparatus 100 for producing media contents in a duet mode according to an embodiment of the present invention. Referring to FIG. 2, the apparatus 100 for producing media contents in a duet mode according to the embodiment of the present invention includes a storage unit 110, a reproducing unit 130, an output unit 150, an input unit 170, an editing unit 180, and a mixing unit 190.

First, the storage unit 110 of the apparatus 100 for producing media contents is stored with the multi-track audio file in which the accompaniment track and the vocal track corresponding thereto are synthesized with each other, the reproducing unit 130 simultaneously reproduces independently the vocal track and the accompaniment track in the multi-track audio file stored in the storage unit 110, and the vocal track and the accompaniment track independently reproduced by the reproducing unit 130 are simultaneously output through the output unit 150 to be transmitted to a user.

Meanwhile, the input unit 170 of the apparatus 100 for producing media contents includes an input panel to which various control commands for the apparatus 100 for producing media contents are input from the user, an audio input terminal such as a microphone terminal to which external audio signals are input, and a video input terminal to which external video signals are input.

In detail, the user may control a volume of the vocal track in the multi-track audio file reproduced by the reproducing unit 130 through the input panel of the input unit 170. In this case, the editing unit 180 generates a volume control vale and a volume control history value from the user according to a volume control command of the vocal track.

Specifically, the volume control value is generated as a value ranging from ‘0’ to ‘1.’ When the user controls the volume of the vocal track to a maximum output of 100%, the volume control value is generated as ‘1’ and when the user erases the volume of the vocal track, the volume control value is generated as ‘0.’

Meanwhile, the volume control values generated according to the volume control of the vocal track by the user are stored in the storage unit 110 in a predetermined time period (for example, unit of 0.1 seconds). As such, the volume values stored in a predetermined time period become the volume control history values for the vocal track.

Therefore, the mixing unit 190 of the apparatus 100 for producing media contents generates the synthesized audio file by synthesizing a vocal track data to which the volume control value is applied, the accompaniment track data, and a user's voice data input through the input unit 170.

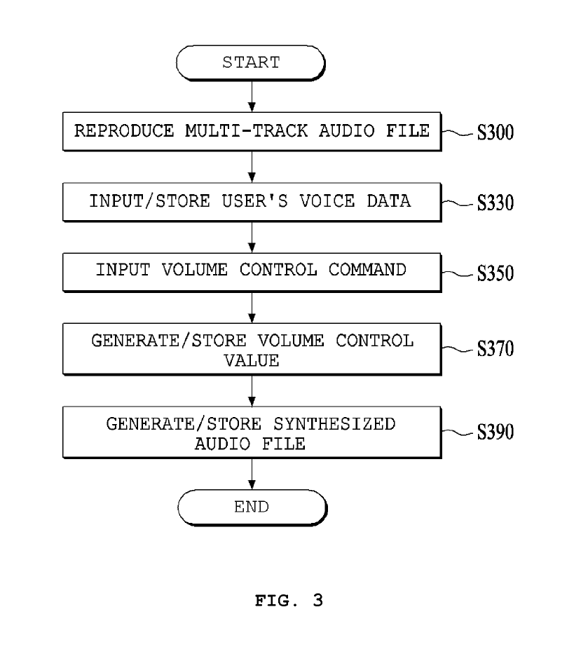

FIG. 3 is a flow chart describing an execution process of a method for producing media contents in a duet mode according to a first embodiment of the present invention. The execution process of the method for producing media contents in a duet mode according to the first embodiment of the present invention will be described with reference to FIGS. 1 to 3. First, a user reproduces the multi-track audio file stored in the storage unit 110 of the apparatus 100 for producing media contents according to the present invention through the reproducing unit 130 (S310), and then sings a song to the accompaniment into a microphone connected to a microphone input terminal included in the apparatus 100 for producing media contents while listening to the vocal and the accompaniment output through the output unit 150.

Therefore, the user's voice data is input through the input unit 170 and the input voice data is stored in the storage unit 110 (S330).

Meanwhile, if the user wants to replace a specific vocal section of a singer that is reproducing by his/her voice to perform mixing, he/she erases the volume of the vocal track in the corresponding section using the input panel. If the user wants to reduce a vocal volume in the specific vocal section of the singer that is producing and perform the mixing to overlap his/her voice in the corresponding section, he/she may also reduce the volume of the vocal track in the corresponding section using the input panel using the input panel 50).

Thereby, the editing unit 180 of the apparatus 100 for producing media contents generates the volume control value and the volume control history value, which are stored in the storage unit 110 (S370).

Meanwhile, the mixing unit 190 mixes the vocal track data to which the volume control value generated in step S370 is applied, the accompaniment track data, and the user's voice data input through the input unit 170 in real time, which may be represented by [vocal track data*volume control value+accompaniment track data+voice data], according to the reproduction of the multi-track audio file and the user's voice input to generate the synthesized audio file in a duet mode. Herein, the synthesized audio file generated as described above is stored in the storage unit 110 (S390).

Meanwhile, in carrying out the present invention, the mixing unit 190 preferably performs the mixing in a decompressed digital RAW audio format such as WAV and preferably performs the mixing in a sampling unit of a digital audio.

In this regard, since the volume control value is generated in a predetermined period (for example, unit of 0.1 seconds), if a total of reproducing time of the multi-track audio file is 1 minute, a total of 600 volume control values are generated, which forms the volume control history value.

Since the mixing is preferably performed in a sampling unit of the digital audio, the number of audio samples of the vocal track and the total number of volume control values are the same as each other and the number of audio samples of the vocal track preferably corresponds to the volume control values one to one (1:1).

However, if the number of audio samples of the vocal track is larger than the total number of volume control values, the corresponding volume control value may not present in the audio sample of the vocal track. In this case, the volume control value applied to the audio sample present followed by the corresponding audio sample may be preferably applied.

Meanwhile, in carrying out the present invention, the mixing unit 190 does not perform the mixing in real time according to the user's voice input in the above-described step S390, and may use the user's voice data stored in storage unit 110 in the above-described step S330, the volume control history value stored in the storage unit 110 in the above-described step S370, and the multi-track audio file pre-stored in the storage unit 110 to perform the mixing later.

Meanwhile, the editing unit 180 of the apparatus 100 for producing media contents may combine video contents pre-stored in the storage unit 110 or input through the video terminal of the input unit 170 with the synthesized audio file generated in the above-described step 5390 according to the user's selection, to produce a moving picture user created content (UCC) in a duet mode.

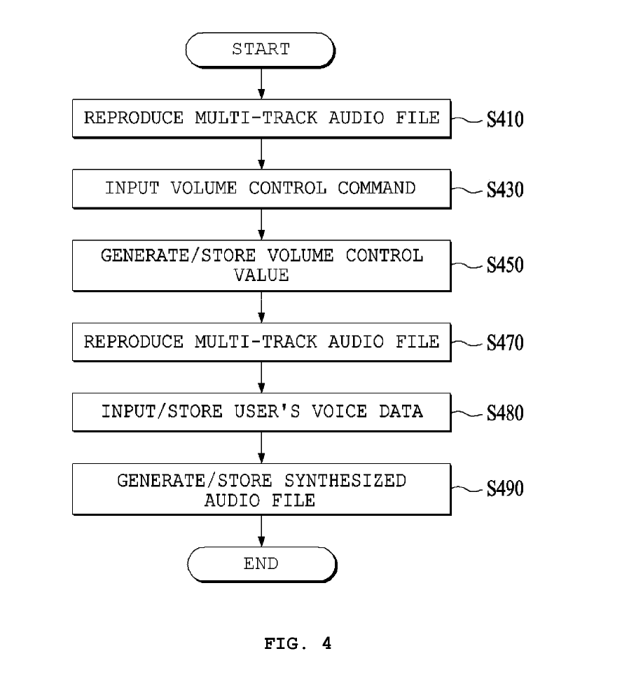

FIG. 4 is a flow chart describing an execution process of a method for producing media contents in a duet mode according to a second embodiment of the present invention. The method for producing media contents in a duet mode according to the second embodiment of the present invention will be described with reference to FIGS. 1, 2, and 4. First, a user reproduces the multi-track audio file stored in the storage unit 110 of the apparatus 100 for producing media contents according to the present invention using the reproducing unit 130 (S410).

Meanwhile, if the user wants to replace a specific vocal section of a singer that is reproducing by his/her voice to perform mixing later, he/she erases the volume of the vocal track in the corresponding section using the input panel. If the user wants to reduce a vocal volume in the specific vocal section of the singer that is producing and perform the mixing to overlap his/her voice in the corresponding section, he/she may also reduce the volume of the vocal track in the corresponding section using the input panel (S430).

Therefore, the editing unit 180 of the apparatus 100 for producing media contents generates the volume control value and the volume control history value, which are stored in the storage unit 110 (S450).

Next, the user again reproduces the corresponding multi-track audio file using the reproducing unit 130 (S470), and then sings a song into a microphone connected to the input unit 170 while listening to the signer's vocal and the accompaniment output through the output unit 150. Meanwhile, the user may also sing a song into the microphone only in a section in which he/she wants to mix his/her voice while listening to the signer's vocal and the accompaniment. Therefore, the user's voice data is input through the input unit 170 and the input voice data is stored in the storage unit 110 (S480).

Meanwhile, the mixing unit 190 mixes the vocal track data to which the volume control value generated in the above-described step S450 is applied, the accompaniment track data, and the user's voice data input/stored in the above-described step S480, which may be represented by [vocal track data*volume control value+accompaniment track data +voice data], to generate the synthesized audio file in a duet mode. Herein, the synthesized audio file generated as described above is stored in the storage unit 110 (S490).

Even when the user sings a song in the entire section in the above-described step S480, the user's voice data is not mixed in a section in which the volume control value is ‘1.’ Meanwhile, the mixing is performed to completely replace the singer's vocal track data by the user's voice data in a section in which the volume control value is ‘0’ and when the volume control value is generated as a value ranging from ‘0’ and ‘1,’ the mixing is performed to mix the singer's vocal volume with the user's voice volume according to a ratio of the volume control value and a value obtained by subtracting the volume control value from 1.

In accordance with the method for producing media contents in a duet mode according to the second embodiment of the present invention in FIG. 4, like the method for producing media contents in a duet mode according to the first embodiment of the present invention in FIG. 3, it is not necessary for the user to control the volume of the vocal track while singing a song. As a result, the user may concentrate only on singing upon his/her voice input.

Further, the editing unit 180 of the apparatus 100 for producing media contents may combine video contents pre-stored in the storage unit 110 or input through the video terminal of the input unit 170 with the synthesized audio file generated in the above-described step S490 according to the user's selection, to produce a moving picture user created content (UCC) in a duet mode.

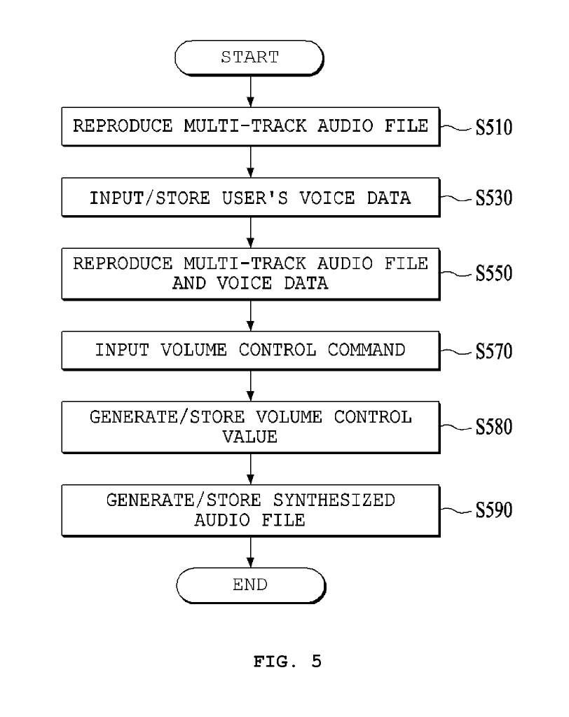

FIG. 5 is a flow chart describing an execution process of a method for producing media contents in a duet mode according to a third embodiment of the present invention. The execution process of the method for producing media contents in a duet mode according to the third embodiment of the present invention will be described with reference to FIGS. 1, 2, and 5. First, a user reproduces the multi-track audio file stored in the storage unit 110 of the apparatus 100 for producing media contents according to the present invention through the reproducing unit 130 (S510), and then sings a song into the microphone connected to the input unit 170 while listening to the singer's vocal and the accompaniment output through the output unit 150.

Meanwhile, the user may also sing a song into the microphone only in a section in which he/she wants to mix his/her voice while listening to the signer's vocal and the accompaniment. Therefore, the user's voice data is input through the input unit 170 and the input voice data is stored in the storage unit 110 (S530).

Next, the user simultaneously reproduces the multi-track audio file stored in the storage unit 110 and the stored user's voice data in the above-described step S530 using the reproducing unit 130 (S550).

Meanwhile, if the user wants to replace a specific vocal section of a singer that is reproducing by his/her voice that is simultaneously reproducing to perform mixing, he/she erases the volume of the vocal track in the corresponding section using the input panel. If the user wants to reduce a vocal volume in the specific vocal section of the singer that is producing and perform the mixing to overlap his/her voice in the corresponding section, he/she may also reduce the volume of the vocal track in the corresponding section using the input panel (S570).

Therefore, the editing unit 180 of the apparatus 100 for producing media contents generates the volume control value and the volume control history value, which are stored in the storage unit 110 (S580).

Meanwhile, the mixing unit 190 mixes the vocal track data to which the volume control value generated in the above-described step S450 is applied, the accompaniment track data, and the user's voice data, which may be represented by [vocal track data*volume control value+accompaniment track data+voice data], to generate the synthesized audio file in a duet mode. Herein, the synthesized audio file generated as described above is stored in the storage unit 110 (S590).

As such, in accordance with the method for producing media contents in a duet mode according to the third embodiment of the present invention in FIG. 5, since the mixing operation is performed in the state in which the user's voice data is secured by the above-described step S530, the user may repeat the mixing operation in the above-described steps S570 and S580 until he/she gets the desired results without singing a song every time.

Further, the editing unit 180 of the apparatus 100 for producing media contents may combine video contents pre-stored in the storage unit 110 or input through the video terminal of the input unit 170 with the synthesized audio file generated in the above-described step S590 according to the user's selection, to produce a moving picture user created content (UCC) in a duet mode.

Although preferred embodiments and applications of the present invention have been described above, the present invention should not be construed as being limited to the above described specific embodiments and applications, but may be variously modified and embodied by a person having ordinary skill in the art to which the present invention pertains without departing from the gist of the present invention claimed in the appended claims. Such modifications should not be considered as departing from the technical idea or scope of the present invention.

In addition, terms used herein are for the purpose of describing specific embodiments only, but are not intended to limit the present invention. A singular form includes a plural form unless the context clearly indicates otherwise. Throughout this specification, it will be understood that the term “comprise” and variations thereof, such as “comprising” and “having”, specify the presence of features, numbers, steps, operations, components, parts, or combinations thereof, described in the specification, but do not preclude the presence or addition of one or more other features, numbers, steps, operations, components, parts, or combinations thereof.

### INDUSTRIAL APPLICABILITY

The present invention is applicable in the music contents-related industrial field.

1. A method for producing media contents in a duet mode, comprising:
(a) reproducing, by a media file editing apparatus, a multi-track audio file in which an accompaniment track and a vocal track corresponding to the accompaniment track are synthesized with each other;
(b) receiving, by the media file editing apparatus, a volume control command of the vocal track from a user; and
(c) producing, by the media file editing apparatus, a volume control value according to the volume control command.

2. The method of claim 1, further comprising: generating, by the media file editing apparatus, a synthesized audio file by synthesizing a vocal track data to which the generated volume control value is applied, the accompaniment track data, and an a user's voice data.

3. The method of claim 2, further comprising: combining, by the media file editing apparatus, the synthesized audio file with a moving picture file.

4. The method of claim 2, wherein the number of volume control values and the number of samples of the vocal track data are the same as each other.

5. An apparatus for producing media contents, comprising:
a reproducing unit configured to reproduce a multi-track audio file in which an accompaniment track and a vocal track corresponding to the accompaniment track are synthesized with each other;
an input unit configured to receive a volume control command of the vocal track from a user; and
an editing unit configured to generate a volume control value according to the volume control command.

6. The apparatus of claim 5, further comprising: a mixing unit configured to generate a synthesized audio file by synthesizing a vocal track data to which the volume control value generated by the editing unit is applied, the accompaniment track data, and an a user's voice data.

7. The apparatus of claim 6, wherein the editing unit combines the synthesized audio file with a moving picture file.

8. The method of claim 6, wherein the number of volume control values and the number of samples of the vocal track data are the same as each other.
